(19) United States
(12) Patent Application Publication
(10) Pub. No.: US 2024/0166038 A1
(43) Pub. Date: May 23, 2024

(54) TONNEAU COVER

(71) Applicant: Rivian IP Holdings, LLC, Irvine, CA (US)

(72) Inventors: Randall R. FRANK, Northville, MI (US); Daniel Patrick MOLL, Yorba Linda, CA (US); Greg WITTEN, Charlbury (GB); Michael JOCZ, Novi, MI (US); Amir MOHAMMADI NASAB, Irvine, CA (US); Bhushan NAGARAJAN, Tustin, CA (US); Shakshi HIMMATRAMKA, Irvine, CA (US); Molly HURLEY, Irvine, CA (US); Saxon ADEN, Irvine, CA (US); Yichi ZHANG, Irvine, CA (US)

(21) Appl. No.: 18/511,937

(22) Filed: Nov. 16, 2023

Related U.S. Application Data
(60) Provisional application No. 63/426,705, filed on Nov. 18, 2022.

(51) Int. Cl. B60J 10/84; B60J 10/27; B62D 33/04

(52) U.S. Cl. CPC B60J 10/84; B60J 10/27; B62D 33/04

(57) ABSTRACT

Aspects of the subject disclosure relate to tonneau covers that include features that interact with each other to facilitate loading and unloading of panels linearly and with high stability. Such features can provide smooth deployment and retraction of the tonneau cover. A tonneau cover can include individual panels that interlock with each other upon deployment and disconnect from each other upon retraction to controllably cover a truck bed or other region of a vehicle, such as a truck. Tonneau covers described herein can include panels that provide reliable sealing there between. Tonneau covers described herein can include panels that provide smooth sliding across each other and along one or more rails. Tonneau covers described herein can perform such operations with minimal noise generation.

### CROSS-REFERENCE TO RELATED APPLICATION

This application claims the benefit of U.S. Provisional Application No. 63/426,705, entitled “TONNEAU COVER,” filed Nov. 18, 2022, the entirety of which is incorporated herein by reference.

### INTRODUCTION

The present description relates generally to vehicles, including, for example, tonneau covers for vehicles.

Tonneau covers may generally include systems that may provide shelter and protection of cargo that may be stored within the cargo area of certain adventure vehicles, such as pickup trucks. As it may be appreciated, drivers or owners of such adventure vehicles may often utilize their vehicles, for example, for camping, off-roading, or other similar recreational outdoors activities. It may be thus useful to provide a tonneau cover that may be adaptable for multiple purposes.

### SUMMARY

The present disclosure generally relates to tonneau covers that include features that interact with each other to facilitate loading and unloading of panels linearly and with high stability. Such features can provide smooth deployment and retraction of the tonneau cover. A tonneau cover can include individual panels that interlock with each other upon deployment and disconnect from each other upon retraction to controllably cover a truck bed or other region of a vehicle, such as a truck. Tonneau covers described herein can include panels that provide reliable sealing there between. Tonneau covers described herein can include panels that provide smooth sliding across each other and along one or more rails. Tonneau covers described herein can perform such operations with minimal noise generation.

In some embodiments, a seal for a panel of a vehicle tonneau cover can include a stem having a first end and a second end; a first branch extending away from a middle portion between the first end and the second end; and a second branch extending from the first end of the stem and across an end of the first branch. The seal can further include an anchor portion extending from the first end of the stem in a direction that is away from the second branch. The second branch can define a curve from the first end of the stem and across the end of the first branch. An inner seal can include an inner seal stem having an inner seal first end and an inner seal second end; an inner seal branch extending away from the first end and towards the outer seal, wherein the inner seal stem and the inner seal branch form an indentation having a dimension that is greater than a dimension of an opening to the indentation.

In some embodiments, a panel for a vehicle tonneau cover can include a slat defining a tooth configured to engage a receptacle of an adjacent panel; and sliders on opposing lateral sides of the slat, wherein each of the sliders defines a planar surface on an upper side of the panel and a bump protruding from the planar surface, wherein the bump extends laterally across the planar surface from a lateral side of the corresponding one of the sliders. A width of the bump can be substantially equal to a width of the planar surface. Each of the sliders further can define an additional planar surface at a lower side of the panel, opposite the upper side of the panel, wherein the width of the bump is substantially equal to a width of the additional planar surface.

In some embodiments, a panel for a vehicle tonneau cover can include a slat defining a tooth extending from an upper side of the panel, defining a longitudinal end of the slat, and being configured to engage a receptacle of an adjacent panel; a first slider on a first lateral side of the slat; and a second slider on a second lateral side of the slat, wherein the slat defines a slat recess between the tooth and the first slider, wherein the first slider defines a slider recess adjacent to the slat recess, wherein the slat recess and the slider recess are configured to receive a portion of a cover driver upon longitudinal movement of the panel. The panel can define a ramp extending from a lower side of the panel toward the upper side of the panel, wherein the ramp faces the slat recess and the slider recess. The portion of the cover driver can include a pinion gear configured to engage a portion of the first slider.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates a perspective view of a vehicle a cargo area, in accordance with implementations of the subject technology.

FIG. 1B illustrates a perspective view of a rear portion of a vehicle including a tonneau cover in a partially deployed configuration, in accordance with implementations of the subject technology.

FIG. 1C illustrates a top view of the rear portion of the vehicle of FIG. 1B including the tonneau cover in a fully deployed configuration, in accordance with implementations of the subject technology.

FIG. 1D illustrates a side view of a cover system for controlling deployment of a tonneau cover, in accordance with implementations of the subject technology.

FIG. 2 illustrates a perspective view of a cover system with a tonneau cover in a retracted configuration, in accordance with implementations of the subject technology.

FIG. 3 illustrates a perspective view of the cover system of FIG. 2 with the tonneau cover in a deployed configuration, in accordance with implementations of the subject technology.

FIG. 4 illustrates a perspective exploded view of a cover system, in accordance with implementations of the subject technology.

FIG. 5 illustrates a side sectional view of a portion of a tonneau cover with interlocked panels, in accordance with implementations of the subject technology.

FIG. 6 illustrates a side sectional view of a portion of a tonneau cover with interlocked panels, in accordance with implementations of the subject technology.

FIG. 7 illustrates a side view of a seal of a tonneau cover, in accordance with implementations of the subject technology.

FIG. 8 illustrates a perspective view of panels of a tonneau cover, in accordance with implementations of the subject technology.

FIG. 9 illustrates a perspective view of panels of a tonneau cover, in accordance with implementations of the subject technology.

FIG. 10 illustrates a perspective view of panels of a tonneau cover, in accordance with implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Embodiments of the present disclosure are directed toward a multi-purpose cover (e.g., tonneau cover) for an adventure vehicle, such as a pickup truck, a crossover utility vehicle (CUV), or a sport utility vehicle (SUV). In some embodiments, the multi-purpose cover may be adaptably disposed onto the vehicle in each of a deployed configuration and a retracted configuration. For example, in some embodiments, in the deployed configuration, the multi-purpose cover may overlap a cargo area of the vehicle. In some embodiments, the multi-purpose cover may be attached to a perimeter of the cargo area via an attachment mechanism. In some embodiments, a motion control mechanism may be utilized to cause the multi-purpose cover to extend in a first direction so as to cover the cargo area and to retract in a second direction so as to uncover the cargo area.

In this way, the multi-purpose cover may adaptably operate in the deployed configuration as a tonneau cover to extend and protect the cargo area of the vehicle and the driver or owner's cargo from environmental elements (e.g., precipitation, sunlight, wind, debris, and so forth). The multi-purpose cover may also operate in the retracted configuration in a storage region and away from the cargo area. A tonneau cover can be operated with powered deployment and retraction capabilities. It can be desirable to perform such operations with minimal noise. Additionally, it can be desirable to provide the tonneau cover with individual components (e.g., panels) that can connect and disconnect from each other in a manner that avoids binding or jamming.

Implementations of the subject technology described herein provide tonneau covers that include features that interact with each other to facilitate loading and unloading of panels linearly and with high stability. Such features can provide smooth deployment and retraction of the tonneau cover. A tonneau cover can include individual panels that interlock with each other upon deployment and disconnect from each other upon retraction to controllably cover a truck bed or other region of a vehicle, such as a truck. Tonneau covers described herein can include panels that provide reliable sealing there between. Tonneau covers described herein can include panels that provide smooth sliding across each other and along one or more rails. Tonneau covers described herein can perform such operations with minimal noise generation.

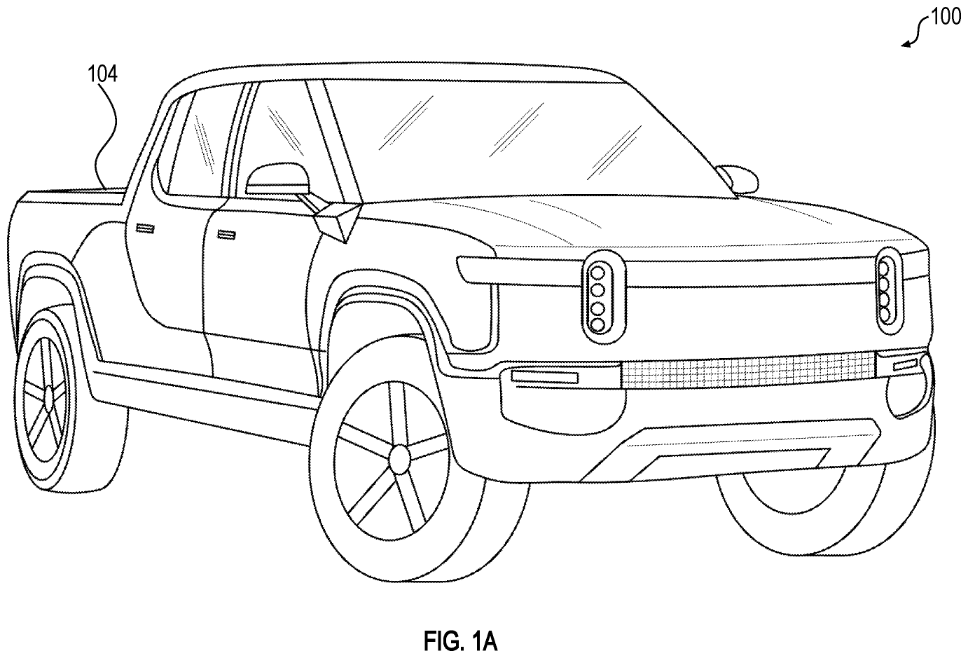

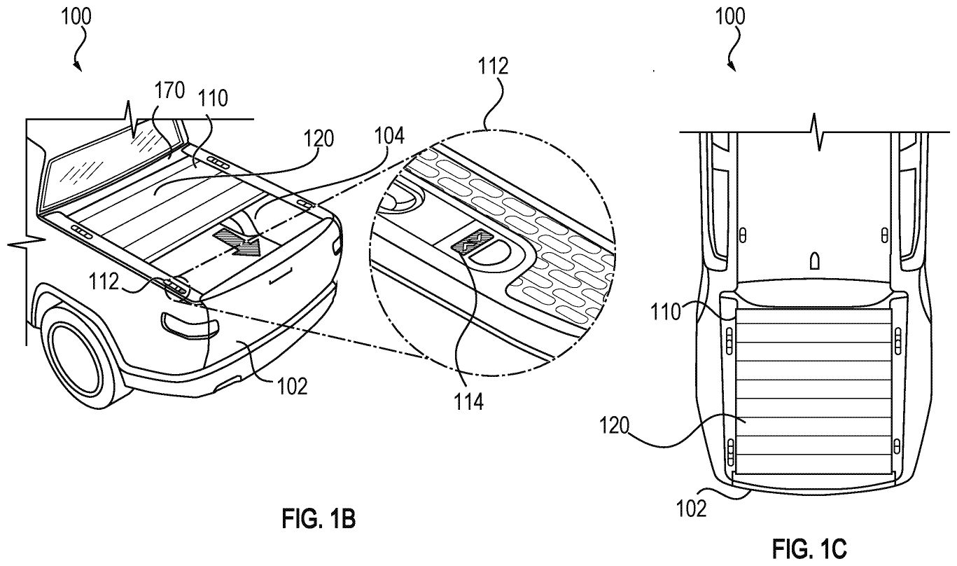

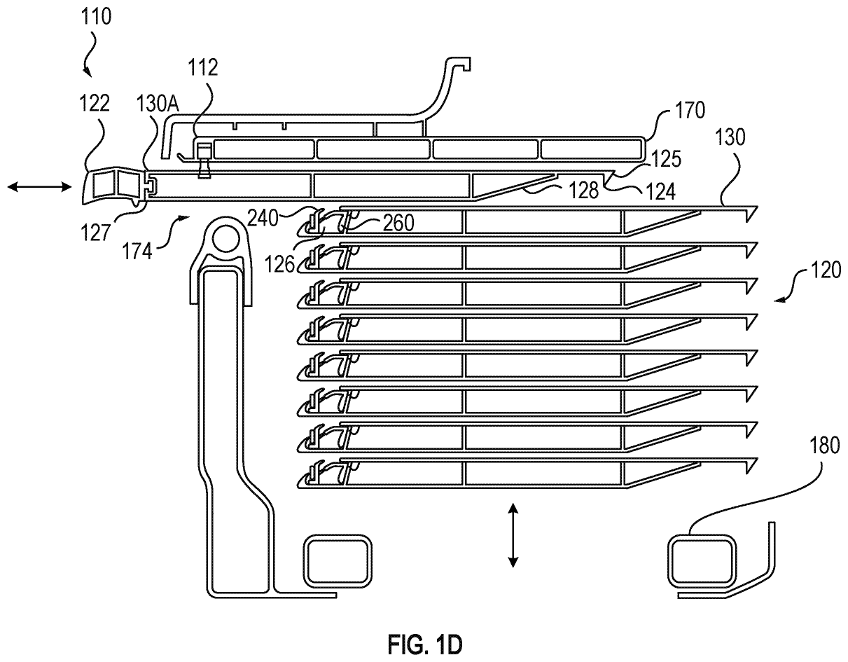

FIG. 1A illustrates an example embodiment of a vehicle 100, in accordance with the presently disclosed embodiments. As depicted, the vehicle 100 may include any passenger vehicle (e.g., a car, a truck, a pickup truck, a sports utility vehicle (SUV), a minivan, a crossover utility vehicle (CUV), a cargo van, a towing truck) that may be utilized for transportation and to navigate one or more rural environments, urban environments, and/or off-roading and mountainous environments. In some embodiments, the vehicle 100 may include a gasoline-powered vehicle that may be propelled, for example, by an internal combustion engine (ICE) or other fuel-injection engine.

In some embodiments, the vehicle 100 may include, for example, an electric vehicle (EV), a battery electric vehicle (BEV), a hybrid electric vehicle (HEV), a plug-in hybrid electric vehicle (PHEV), or other vehicle 100 that may be in part or wholly propelled by one or more electric motors (e.g., synchronous electric motors, permanent magnet synchronous electric motors (PMSMs), induction motors (IMs), line start synchronous motors (LSSMs), line start permanent magnet motors (LSPMMs), synchronous reluctance motors (SynRMs) utilizing power stored to one or more batteries included in the vehicle 100.

In some embodiments, the vehicle 100 may include a cargo area 104, for example at a rear or other portion of the vehicle 100. The cargo area 104 can define a space that can be covered by a multi-purpose cover (e.g., tonneau cover).

FIGS. 1B and 1C illustrate an example of the vehicle 100 including a multi-purpose cover that is configured to be adjusted to be in one of multiple selectable configurations. In some embodiments, the multi-purpose cover can be a tonneau cover 120. In some embodiments, a driver or owner of the vehicle 100 may desire to couple the tonneau cover 120 to the vehicle 100. For example, as will be further appreciated, the tonneau cover 120 may include any cover (e.g., textile cover, rigid cover) that may be suitable for being adaptably disposed onto the vehicle 100 in one of multiple configurations (e.g., a tonneau cover configuration to extend and retract to protect the cargo area of the vehicle 100 and the driver or owner's cargo from environmental elements).

As further depicted by FIGS. 1B and 1C, in some embodiments, in the deployed configuration, the tonneau cover 120 may be configured to overlap the cargo area 104 of the vehicle 100 by controlling deployment and retraction of the tonneau cover 120 utilizing, for example, one or more cover drivers 112. In some embodiments, the one or more cover drivers 112 may include one or more motion control mechanisms, such as a motor, actuator, gear drive, and the like. The one or more cover drivers 112 may further include one or more supporting features, such as gears, tracks, chains, bands, belts, linkages, rack and pinion mechanisms, and the like, to convert activity of the one or more cover drivers 112 into controlled motion of the tonneau cover 120.

For example, in some embodiments, in the deployed configuration, the tonneau cover 120 may include an electromechanical tonneau cover that may be configured to controllably (e.g., electrically) overlap the cargo area 104 of the vehicle 100. For example, in some embodiments, the tonneau cover 120 may be attached to a perimeter of the cargo area 104 via the one or more cover drivers 112 (e.g., rack and pinion mechanism). For example, in some embodiments, the one or more cover drivers 112 may be utilized to cause the tonneau cover 120 to extend in a first direction so as to cover the cargo area 104 and to retract in a second direction (e.g., opposite the first direction) so as to uncover the cargo area 104.

In some embodiments, the one or more cover drivers 112 may include a rack and pinion mechanism that may operate to cause the tonneau cover 120 to extend in the first direction so as to cover the cargo area 104 and to retract in the second direction (e.g., in a direction opposite the first direction) so as to uncover the cargo area 104 in response to receiving one or more command signals. For example, in some embodiments, the one or more cover drivers 112 may include a user input device 114 (e.g., one or more pushbuttons) that may be utilized by the driver or owner of the vehicle 100 to interact with a control system of the vehicle 100 for operating the tonneau cover 120. For example, in some embodiments, in response to the driver or owner interacting with the user input device 114 (e.g., one or more pushbuttons), the control system (e.g., control circuitry, controllers, and/or processors) may provide one or more command signals to the one or more cover drivers 112 to cause the tonneau cover 120 to extend in the first direction so as to cover the cargo area 104 and to retract in the (e.g., in a horizontal direction opposite the first direction) so as to uncover the cargo area 104.

In some embodiments, the vehicle 100 can further include a cartridge 170 for receiving the tonneau cover 120 while in a retracted configuration. The tonneau cover 120 can be deployed from the cartridge 170, for example with operation of the cover drivers 112. The cartridge 170 can be on a first side of the cargo area 104, for example, near a cab or other region of the vehicle 100.

In some embodiments, the vehicle can further include a tailgate 102 that can transition between an open configuration to provide access to the cargo area and a closed configuration to enclose a portion of the cargo area. The tailgate 102 can be on a second side of the cargo area 104, for example, opposite the cartridge 170. While in the closed configuration, the tonneau cover 120 can be deployed in a direction of the tailgate 102. When fully deployed, the tonneau cover 120 can optionally abut the tailgate 102, for example to form a seal therewith.

FIG. 1D illustrates a cover system 110 including a cover driver 112, in accordance with the presently disclosed embodiments. The tonneau cover 120 can include multiple panels 130 that can be stored in a retracted configuration within the cartridge 170, as shown in FIG. 1D. The panels 130 can be stored in a stacked arrangement within the cartridge 170 while in the retracted configuration. For example, the ends of the panels 130 can be decoupled from each other while within the cartridge 170.

The tonneau cover 120 can transition from the retracted configuration to the deployed configuration by deploying the panels 130 from the cartridge 170. For example, cover driver 112 can be operated to move a topmost one of the panels 130 in the cartridge 170 (e.g., in the stack) to move out of an opening 174 in the cartridge. The tonneau cover 120 may interact with the cover driver 112 (e.g., a rack and pinion system). For example, the cover driver 112 may include, a pinion portion (e.g., a motorized wheel) interlocking with a rack portion (e.g., at the topmost one of the panels 130) and making one or more circular movements to cause each of multiple panels 130 of the tonneau cover 120 to move in either of two directions (e.g., through the opening 174). Specifically, in accordance with the present embodiments, causing the rack (e.g., formed by the engaged one of the panels 130) to move in either of the two directions may, by extension, cause the tonneau cover 120 to extend in a first direction (e.g., out of the cartridge 170) and to retract in a second direction (e.g., into the cartridge 170).

In the example of FIG. 1D, the end panel 130A is at the top of the stack and is in the process of being moved through the opening 174. The end panel 130A can optionally include an end seal 122 to engage a tailgate of the vehicle. As each of the panels 130 is deployed out of the cartridge 170 and/or through the opening 174 (e.g., by the cover driver 112), each panel 130 engages an underlying panel 130 to achieve a secure connection there between. For example, one or more of the panels 130 can include a first engager on a first longitudinal side 125 of the panel 130 and a second engager on a second longitudinal side 127 of the panel 130, opposite the first longitudinal side. As shown in FIG. 1D, the first engager can be implemented as a tooth 124, and the second engager can be implemented as a receptacle 126. As an upper one of the panels 130 moves out of the opening 174, the tooth 124 thereof can engage the receptacle 126 of an adjacent and lower other one of the panels 130. The tooth 124 and the receptacle can engage each other, so that the pair of panels 130 coupled thereby move together in unison. For example, the panel 130 having the tooth 124 can pull the panel 130 having the receptacle 126 out of the opening. As any given panel 130 is moved out of the cartridge, a follower assembly 180 can bias the panels 130 still within the cartridge toward the opening 174 to be aligned therewith and to present a corresponding receptacle 126 for engagement by a tooth 124 of a panel 130 that is exiting through the opening 174. This process can be repeated for each of the panels 130 until the last and/or lowermost one of the panels 130 is engaged to form the tonneau cover 120 in a deployed configuration.

It will be understood that the process described herein can be reversed to retract the tonneau cover 120 and the panels 130 thereof into the cartridge 170. As each of the panels 130 is retracted into the cartridge 170 and/or through the opening 174 (e.g., by the cover driver 112), each panel 130 disengages an underlying panel 130 to release the connection there between. For example, as an outer panel 130 is driven (e.g., by the cover driver 112) against an adjacent and inner panel 130 that is already fully within the cartridge 170, the tooth 124 can urge the inner panel 130 downward into the cartridge 170 (e.g., against the bias of the follower assembly 180). Such action can be provided by the shape, geometry, size, and/or other features of the tooth 124 and/or the receptacle 126. By further example, each panel 130 can include a ramp 128 that is also configured to urge the adjacent and inner panel 130 downward into the cartridge 170 (e.g., against the bias of the follower assembly 180) as the outer panel 130 is drive (e.g., by the cover driver 112) into the cartridge 170 and/or through the opening 174. This process can be repeated for each of the panels 130 until the last and/or uppermost one of the panels 130 (e.g., end panel 130A) is within the cartridge 170. Accordingly, the panels 130 can be arranged in a stacked configuration within the cartridge 170.

As described herein, the follower assembly 180 can provide a biasing force to urge each of the panels 130 stacked within the cartridge 170 upwardly and/or toward the opening 174. Accordingly, until all of the panels 130 are deployed, one of the panels 130 can be maintained at the top region of the cartridge 170 and/or aligned with the opening 174 to be engaged by another of the panels 130 that is exiting the cartridge 170 through the opening 174. As the panels 130 are retracted within the cartridge 170, the follower assembly 180 can move downwardly to accommodate the acceptance of each panel 130 in sequence until the stack is formed.

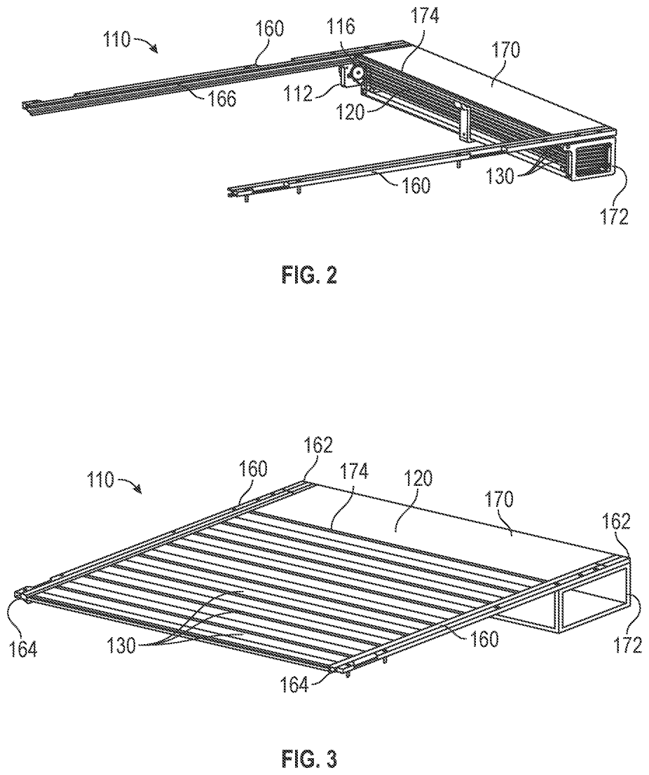

Referring now to FIGS. 2-4, a cover system can include features that facilitate deployment and retraction of a tonneau cover having multiple panels.

As shown in FIG. 2, the cover system 110 can include one or more rails 160, such as a pair of rails 160 on opposing sides of the cargo area. In some embodiments, each of the rails 160 can define a channel 166, such as a recess, a concave portion, a convex portion, a protrusion, and the like, to allow one or more panels 130 of the tonneau cover 120 to slide along the rails 160. Each of the rails 160 on opposing sides of the cargo area can include channels 166 that are directly opposite and/or facing each other. In some embodiments, the rails 160 can include one or more features to facilitate sliding, such as a coating with a low coefficient of friction. This can help reduce friction as the panels 130 slide within the channels 166. In some embodiments, deployment and/or retraction of the panels 130 and sliders 150 can be further assisted by an insert (e.g., of nylon or other low-friction material) within the channel 166, for example including extruded polyoxymethylene.

In the fully retracted configuration, as shown in FIG. 2, the panels 130 of the tonneau cover 120 can be positioned within the cartridge 170. For example, the panels 130 can be stowed in a stacked configuration. In the retracted configuration, the panels 130 can be disengaged from each other. As such, the panels 130 can be initially deployed from the cartridge 170 one at a time. As the panels 130 are deployed, they can engage each other to facilitate deployment of the tonneau cover 120.

In the fully deployed configuration, as shown in FIG. 3, the panels 130 can extend along the rails 160 while the panels 130 are connected to each other. For example, the panels 130 can be coupled end-to-end when the tonneau cover 120 is in a deployed configuration. Such engagement can be achieved while the panels 130 are deployed from the cartridge 170 and/or through the opening 174. The panels 130 can form a continuous and sealed (e.g., water-tight) barrier covering the cargo area. As further shown, the panels 130 of the tonneau cover 120 can extend from a first end 162 (e.g., at the cartridge 170) of the rails 160 to a second end 164 (e.g., at a tailgate) of the rails 160.

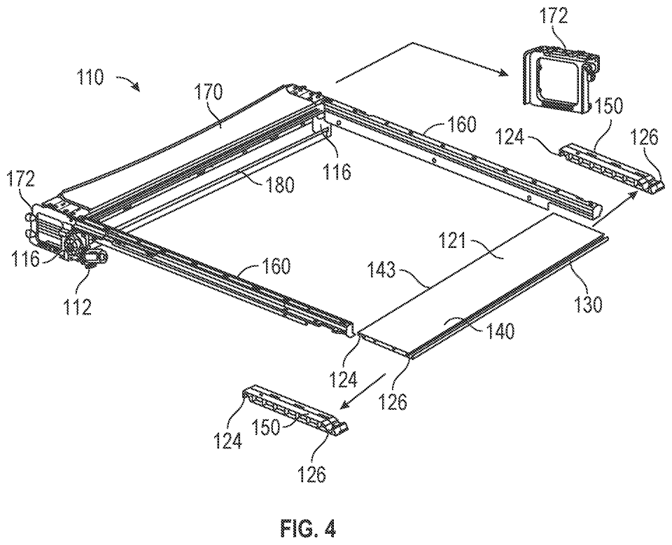

As shown in FIG. 4, the cover driver 112 can be provided to engage one or more panels 130 and push or pull the panels 130 into or out of the cartridge 170 and/or along the rails 160. While only one cover driver 112 is shown, it will be understood that any number of cover drivers can be provided and engage the panels 130 at any one or more portions thereof. It will be further understood that a single driver component (e.g., motor) can be operated to control multiple engagement features (e.g., pinion gears 116) that each engage corresponding ones of multiple structures (e.g., racks) on each of the panels 130. As such, the forces can be distributed and evenly balanced across the panels 130.

As further shown in FIG. 4, each panel 130 can include a slat 140 and one or more sliders 150. The slats 140 can extend across a portion of the space between the rails 160. The sliders 150 can be positioned at each of opposing ends of the slat 140 to facilitate movement along corresponding rails 160. For example, the sliders 150 can provide a shape, size, and/or geometry that is complementary to that of the rails 160 (e.g., at the channels thereof). As such, the sliders 150 can facilitate smooth motion of the panels 130 along the rails 160.

In some embodiments, the slats 140 can include materials that structural support and resistance to wear. For example, materials such as polyamide 66, polyoxymethylene (POM), combinations thereof, and the like, can be selected.

In some embodiments, the sliders 150 can include materials that facilitate slider across each other. For example, materials can be selected for a low or reduced coefficient of friction. In some embodiments, the sliders 150 can include polytetrafluoroethylene, nylon 6. NVH rubber, and the like. By further example, the sliders 150 can include additional materials for support, such as a metal or other rigid structural insert within another material that is optimized for friction reduction.

In some embodiments, the slats 140 can provide or otherwise define the tooth 124 of the panel 130 for engaging a receptacle of another panel (e.g., an adjacent and underlying panel). For example, the tooth 124 can be a consistent shape that extends (e.g., laterally) across an edge of the slat 140 between the sliders 150, optionally without extending to the slider(s) 150 of the given panel 130. As such, the tooth 124 defined by the slat 140 can interact with the receptacle of another (e.g., longitudinally adjacent) panel at its slat. In some embodiments, the slats 140 can provide or otherwise define the receptacle 126 of the panel 130 for engaging a tooth of another panel (e.g., an adjacent and overlapping panel). For example, the receptacle 126 can be a consistent shape that extends (e.g., laterally) across an edge of the slat 140 between the sliders 150, optionally without extending to the slider(s) 150 of the given panel 130. As such, the receptacle 126 defined by both the slat 140 can interact with the tooth of another (e.g., longitudinally adjacent) panel at its slat.

In some embodiments, both the slats 140 and the slider(s) 150 can provide or otherwise define the tooth 124 of the panel 130 for engaging a receptacle of another panel (e.g., an adjacent and underlying panel). For example, the tooth 124 can be a consistent shape that extends (e.g., laterally) continuously across corresponding edges of both the slat 140 and the slider(s) 150 of a given panel 130. As such, the tooth 124 defined by both the slat 140 and the slider(s) 150 can interact with the receptacle of another (e.g., longitudinally adjacent) panel at its slat and its slider(s). In some embodiments, both the slats 140 and the sliders 150 can provide or otherwise define the receptacle 126 of the panel 130 for engaging a tooth of another panel (e.g., an adjacent and overlapping panel). For example, the receptacle 126 can be a consistent shape that extends (e.g., laterally) continuously across corresponding edges of both the slat 140 and the slider(s) 150 of a given panel 130. As such, the receptacle 126 defined by both the slat 140 and the slider(s) 150 can interact with the tooth of another (e.g., longitudinally adjacent) panel at its slat and its slider(s).

The cartridge 170 can include one or more end caps 172. The end caps 172 can cover opposing ends of the cartridge 170 to secure the panels 130 therein while they are in the retracted configuration. In some embodiments, the end caps 172 can be removed to access the panels 130 within the cartridge 170.

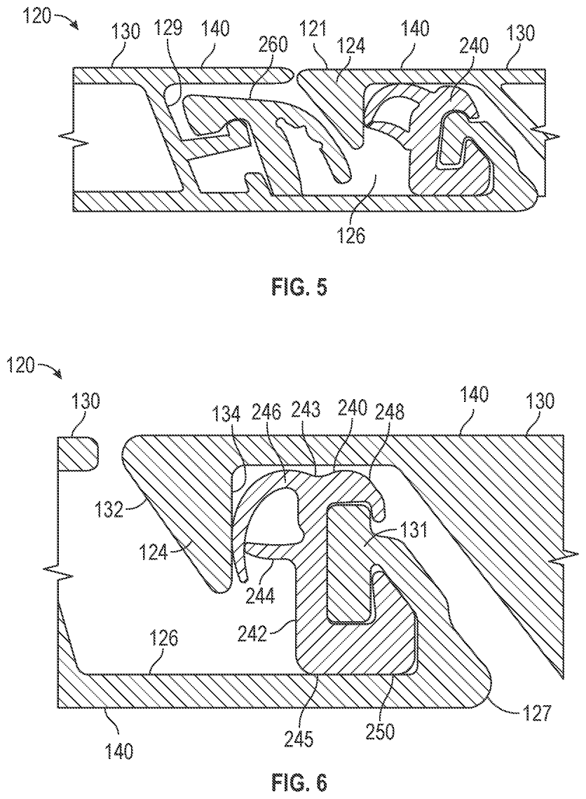

Referring now to FIGS. 5-7, the panels of a tonneau cover can interlock with seals to prevent ingress of debris and fluids.

In some embodiments, as shown in FIG. 5, a tooth 124 of one panel 130 can be received within a receptacle 126 of another panel, so that further movement of the first panel 130 results in corresponding movement of the second panel 130. The tooth 124 can extend or protrude from an upper side 121 of the panel 130 (e.g., at the slat thereof). The receptacle can include a space that longitudinally overlaps with the tooth 124 when the panels 130 are joined together. During connection, the tooth 124 can advance over a portion of the other panel 130 to be aligned within the receptacle 126. The tooth 124 can be received into the receptacle 126 to facilitate transfer of forces (e.g., longitudinal forces) between the panels 130.

As further shown in FIG. 5, at least one of the panels 130 can provide one or more seals within the receptacle 126. In some embodiments, an outer seal 240 can be provided at or near an outer periphery of the receptacle 126. In some embodiments, an inner seal 260 can be provided at or near inner side of the receptacle 126, for example opposite the outer seal 240. As such, the tooth 124 can be engaged by one or both of the outer seal 240 and the inner seal 260 on opposing sides of the tooth 124. One or more seals can be provided to abut one or more sides of the tooth 124, so that debris and fluids are prevented from penetrating through the panels 130, including the connection interface therebetween. For example, the outer seal 240 and/or the inner seal 260 can form a barrier against ingress or egress of debris and fluids there through.

The outer seal 240 and the inner seal 260 of FIG. 5 are shown in a side sectional view. It will be understood that the outer seal 240 and/or the inner seal 260 can extend laterally across a width of a portion of the panel 130. The structures, dimensions, shapes, geometries, and/or profiles of each seal, as further described herein, can be consistent across an entirety of the width thereof. For example, each of the outer seal 240 and the inner seal 260 can define a cross-sectional shape that extends across an entirety of the width thereof. By further example, each of the outer seal 240 and the inner seal 260 can be extruded to form a structure with a consistent cross-sectional shape. Each of the outer seal 240 and the inner seal 260 can extend within slats 140 of the corresponding panel 130. The outer seal 240 and/or the inner seal 260 can extend between sliders (not shown) of the corresponding panel 130. In some embodiments, the outer seal 240 and/or the inner seal 260 can extend into and/or through the sliders. In some embodiments, the outer seal 240 and/or the inner seal 260 can extend within the slats 140 without contacting or extending into the sliders.

In some embodiments, the outer seal 240 can include one or more branches that form a closed loop for engaging the tooth 124 of another panel 130. For example, as shown in FIG. 6, the outer seal 240 can include a stem 242 having a first end 243 and a second end 245. The outer seal 240 can further include a first branch 244 extending away from a middle portion of the stem 242 between the first end 243 and the second end 245. The first branch 244 can extend toward an interior of the receptacle 126. The outer seal 240 can further include a second branch 246 extending from the first end 243 of the stem 242. The second branch 246 can extend toward an interior of the receptacle 126 and form a curve that turns to extend across an end of the first branch 244. For example, at least a portion of the second branch 246 can extend across and/or cover an entirety of a terminal end of the first branch 244. As such, the first branch 244 and the second branch 246 can intersect and/or overlap. The first branch 244 (e.g., an underlying structure) can press against the second branch 246 (e.g., an overlapping structure) to urge it against the tooth 124 or another structure of the panel 130. The second branch 246 can extend sufficiently far beyond the first branch 244, such that it remains over the first branch 244 with secure engagement against the tooth 124 or other structure of the panel 130. As further shown in FIG. 6, the first branch 244 can extend directly towards the tooth 124 (e.g., when present within the receptacle 126), such that the first branch 244 provides biasing forces against the second branch 246 with its column strength. The second branch 246 can extend across an inner surface 134 of the tooth 124, for example, being tangential to the inner surface 134 at the region of contact with the tooth 124. The position of the outer seal 240 and the features described herein provide effective scaling to prevent ingress of debris and fluids with minimal force applied. As such, effective sealing against the tooth 124 can be provided with minimal force from the outer seal 240. By providing a smaller force, the panels 130 are provided with an case of separation when retracted into the cartridge into a stacked configuration. This arrangement helps the retraction and deployment operations of the panels 130 sufficiently quiet and smooth with less chance for binding.

As further shown in FIG. 6, the outer seal 240 can further include one or more anchor portions to secure the outer seal 240 with respect to a portion of the panel 130 (e.g., within the receptacle 126). For example, a first anchor portion 248 can extend from the first end 243 of the stem 242 in a direction that is away from (e.g., opposite) the second branch 246. By further example, a second anchor portion 250 can extend from the second end 245 of the stem 242 in a direction that is away from (e.g., opposite) the receptacle 126. The first anchor portion 248 and/or the second anchor portion 250 can secure the outer seal 240 to a portion of the panel 130. For example, the first anchor portion 248 and/or the second anchor portion 250 can extend at least partially about an anchor end 131 of the panel 130 at or near a second longitudinal side 127 of the panel 130. Additionally or alternatively, the first anchor portion 248 and/or the second anchor portion 250 can extend within a recess of an anchor end 131 of the panel 130 at or near a second longitudinal side 127 of the panel 130. It will be understood that the outer seal 240 and/or the anchor end 131 of the panel 130 can have a uniform cross-sectional shape across widths thereof, such that the outer seal 240 can be slid onto and/or into the anchor end 131 from a lateral side of the slat 140.

Accordingly, the outer seal 240 can sealingly engage against an inner surface 134 of the tooth 124 of another panel 130. As the panels 130 interact with each other, such as with forces applied by a cover driver, the outer seal 240 and tooth 124 can maintain contact and sealing engagement so that the panels 130 move in unison while assembled together in the deployed configuration of the tonneau cover 120.

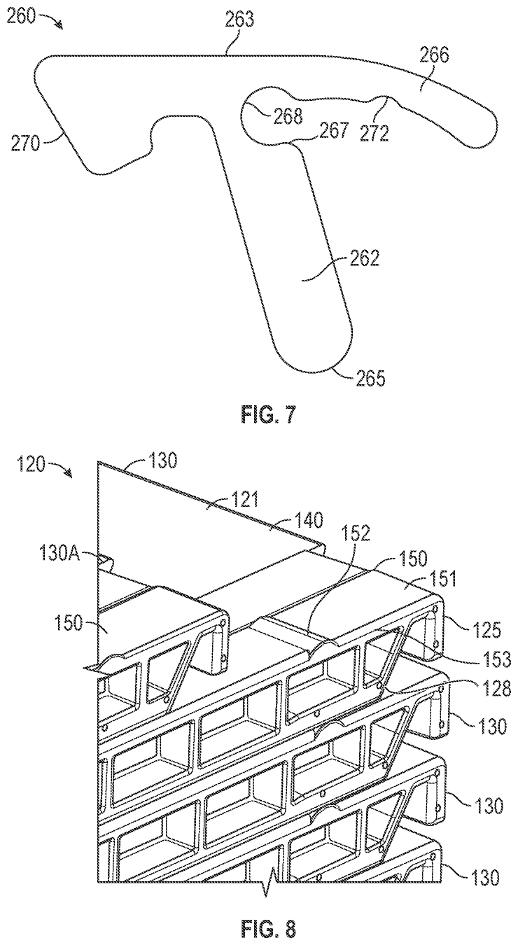

In some embodiments, the inner seal 260 can include one or more branches that form a flexible extension for engaging the tooth 124 of another panel 130. For example, as shown in FIG. 7, the inner seal 260 can include a stem 262 having a first end 263 and a second end 265. The inner seal 260 can further include a branch 266 extending from the first end 263 of the stem 262. The branch 264 can extend toward an interior of the receptacle 126 (see also FIG. 5). The branch 266 can form a curve that turns somewhat toward the second end 265 of the stem 262. As such, the branch 266 can form an angled ramp that engages an outer surface 132 of a tooth 124 of another panel 130 (see also FIG. 5). As further shown in FIG. 7, the branch 264 can initially extend directly towards the tooth 124 (e.g., when present within the receptacle 126), such that the branch 266 provides biasing forces against the tooth 124. The branch 266 can extend across an outer surface 132 of the tooth 124, for example, being tangential to the outer surface 132 at the region of contact with the tooth 124. The position of the inner seal 260 and the features described herein provide effective sealing to prevent ingress of debris and fluids with minimal force applied. As such, effective sealing against the tooth 124 can be provided with minimal force from the inner seal 260. By providing a smaller force, the panels 130 are provided with an ease of separation when retracted into the cartridge into a stacked configuration. This arrangement helps the retraction and deployment operations of the panels 130 sufficiently quiet and smooth with less chance for binding.

As further shown in FIG. 7, the inner seal 260 can include a hinge feature to facilitate movement and/or rotation of the branch 266. The hinge can be provided as an indentation 268 (e.g., recess, cavity, and the like). The indentation 268 can extend into the structure of the inner seal 260 at an interior corner formed at the intersection of the stem 262 and the branch 266 at the first end 263 of the stem 262. For example, the indentation 268 can be defined as an interior space or void with an opening 267 thereto. In some embodiments, the indentation 268 can have a maximum cross-sectional dimension that is greater than a maximum cross-sectional dimension of the opening 267 to the indentation 268. The size and shape of the indentation 268 can be selected to determine the load on the panel 130 (e.g., tooth 124) engaging the branch 266. For example, the size and/or shape of the indentation 268 can be selected to determine a biasing force to be applied to a tooth 124 when the branch 266 is deflected by application of a force from the tooth 124. A sufficiently low load (e.g., large indentation 268) can be selected so that the panels 130 can lay flat (e.g., flush outer surfaces) relative to each other while also providing effective sealing against ingress of fluids and/or debris.

As further shown in FIG. 7, the inner seal 260 can further include one or more anchor portions to secure the inner seal 260 with respect to a portion of the panel 130 (e.g., within the receptacle 126). For example, an anchor portion 270 can extend from the first end 263 of the stem 262 in a direction that is away from (e.g., opposite) the branch 266 and/or the receptacle 126. The anchor portion 270 can secure the inner seal 260 a portion of the panel 130. For example, the anchor portion 270 can extend within a recess of an anchor end 129 of the panel 130 at or near a longitudinal end of the receptacle 126 that is opposite the outer seal 240. Additionally or alternatively, the anchor portion 270 can extend at least partially about an anchor end 129 of the panel 130. It will be understood that the inner seal 260 and/or the anchor end 129 of the panel 130 can have a uniform cross-sectional shape across widths thereof, such that the inner seal 260 can be slid onto and/or into the anchor end 129 from a lateral side of the slat 140.

Accordingly, the inner seal 260 can sealingly engage against an outer surface 132 of the tooth 124 of another panel 130. As the panels 130 interact with each other, such as with forces applied by a cover driver, the inner seal 260 and tooth 124 can maintain contact and sealing engagement so that the panels 130 move in unison while assembled together in the deployed configuration of the tonneau cover 120.

Referring now to FIG. 8, one or more features of a slider can facilitate travel of the panels across each other as well as lateral alignment of the panels. In some embodiments, as shown in FIG. 8, each of the sliders 150 can include a planar surface 151 at the upper side 121 of the corresponding panel 130. A bump 152 can protrude from a planar surface 151 of the slider 150. The bump 152 can extend laterally across the slider 150 near the first longitudinal side 125 of the panel 130. For example, the bump 152 can be on the upper side 121 of the panel 130 and opposite (e.g., protruding away from) the ramp 128 of the panel 130. As such, the bump 152 can be positioned to interact with an overlapping panel 130 stacked above the given panel 130 and interact with the ramp 128 of the overlapping panel 130 thereof when such an overlapping panel 130 is provided onto the upper side 121 of the given panel 130.

As further shown in FIG. 8, the bump 152 can form a uniform and/or consistent cross-sectional shape across a width thereof. In some embodiments, the bump 152 can define a convex or other curved shape that promotes sliding thereon. In some embodiments, the bump 152 can define an uppermost extent of the slider 150 and/or the panel 130, such that an overlapping slider 150 and/or panel 130 applied thereto contacts the bump 152 rather than an entirety of the planar surface 151. The bump 152 can be provided with features to facilitate sliding, such as a coating with a low coefficient of friction. This can help reduce friction as the panels 130 slide over each other.

As further shown in FIG. 8, the bump 152 can extend to a lateral side 153 of the slider 150 and/or the panel 130. Additionally or alternatively, the bump 152 can extend laterally across an entirety of the width of the planar surface 151.

For example, a width of the bump 152 can be substantially equal to a width of the planar surface 151. By further example, each of the sliders 150 can define an additional planar surface 156 at a lower side 123 of the panel 130 (e.g., at the slider 150), opposite the upper side 121 of the panel 130. The width of the bump 152 can be substantially equal to a width of the additional planar surface 156, so that the additional planar surface 156 of an overlapping panel 130 can match the bump 152 of an underlying panel 130. Accordingly, as the sliders 150 are slid over each other, the panels 130 can be maintained with desired lateral alignment relative to each other. In particular, the extension of bumps 152 to the corresponding lateral sides 153 facilitates stacking of the panels 130 with uniform lateral alignment. This can help facilitate precise engagement of the panels 130 to each other when subsequently deployed.

In some embodiments, the sliders 150 can include one or more other features to facilitate sliding. For example, the sliders can include a roller at the upper side 151 and/or the lower side 123, such as a wheel or other structure that is configured to rotate with respect to slider 150. Such a roller can include a bearing, axle, or other structure to facilitate rotation. The roller(s) can roll across an opposing surface of another (e.g., overlapping and/or underlying) panel 130.

In some embodiments, deployment and/or retraction of the panels 130 and sliders 150 can be further assisted by lubricating materials on or incorporated into the bump 152, the planar surface 151, the upper side 151 of the panel 130, and/or the lower side 123 of the panel 130. Lubricating materials can include, for example, polytetrafluoroethylene.

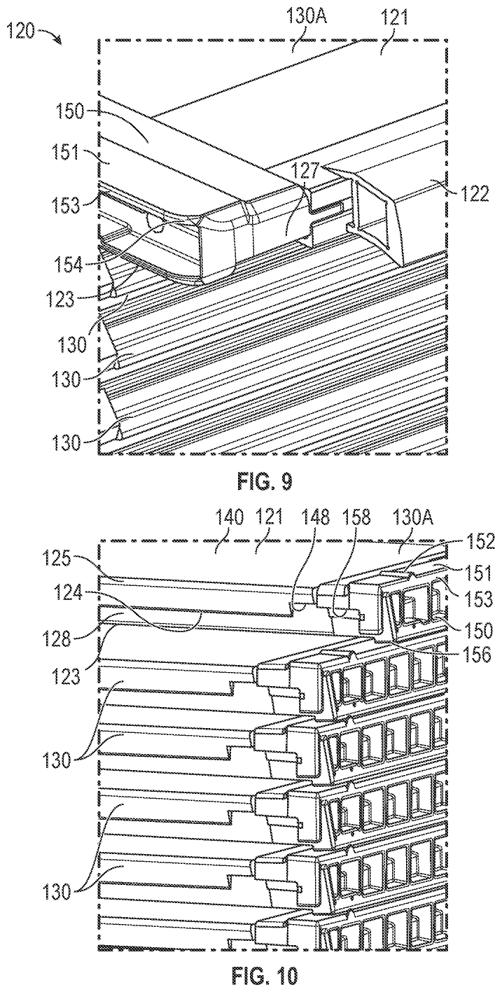

Referring now to FIG. 9, one or more panels can include a transition feature at or near a longitudinal end thereof. Such a transition feature can facilitate transition into and out of the cartridge of the cover system (e.g., through the opening thereof). For example, an interface may be formed between the cartridge and the rails. At such a location, it can be desirable to facilitate passage of the panels without interference.

In some embodiments, as shown in FIG. 9, an end panel 130A can include a slider 150 that forms a transition shape 154 at the second longitudinal side 127 of the panel 130. In some embodiments, the transition shape 154 can provide a transition from the lateral side 153 (e.g., at the slider 150) to the second longitudinal side 127 of the panel 130. In some embodiments, the transition shape 154 can provide a transition from the upper side 121 (e.g., the planar surface 151) to the second longitudinal side 127 of the panel 130. In some embodiments, the transition shape 154 can provide a transition from a lower side 123 (e.g., opposite the upper side 121) to the second longitudinal side 127 of the panel 130. For example, the transition shape 154 can include one or more of a chamfer, curve, spline curve, s-curve, bevel, fillet, radius, taper, step, right angle, and/or another angle. It should be appreciated that the edge geometries shown in FIG. 9 are by way of example and are not to be construed as being limiting. The width and thickness depicted in the figures are not to scale and are only for purposes of illustration. The second longitudinal side 127 can define a leading portion of the tonneau cover 120 when deployed from the cartridge. Thus, by providing the slider with the transition shape 154, initial deployment of the end panel 130A can be executed smoothly with minimal resistance.

As further shown in FIG. 9, the end panel 130A can further include the end seal 122 at the second longitudinal side 127 of the panel 130. The end seal 122 can protrude beyond the transition shape 154. The cargo area and/or the tailgate can include features that complement the shape of the transition shape 154 and/or the end seal 122 for providing sealing engagement therewith.

While FIG. 9 illustrates only one lateral side of the panels 130, it will be understood that the panels 130 can include the same or similar features on each of opposing lateral sides thereof. For example, the sliders 150 on opposing lateral sides of the slat 140 can have symmetrical features, including transition shapes 154.

While FIG. 9 illustrates the end panel 130 having the slider 150 with the transition shape 154, it will be understood that any one or more panels 130 of a tonneau cover 120 can include or omit a transition shape 154. Other panels 130 and the longitudinal ends thereof can include one or more features and/or shapes that facilitate sealing engagement at opposing longitudinal ends of adjacent panels 130.

Referring now to FIG. 10, the panels can include one or more cutouts to facilitate travel over a cover driver. In some embodiments, as shown in FIG. 10, each of the panels 130 can include a slat 140 and sliders 150 on opposing lateral sides of the slat 140. The sliders 150 can each define a lateral side 153 of the corresponding panel 130.

As shown in FIG. 10, the slat 140 can define the tooth 124 at the first longitudinal side 125 of the panel 130, the tooth 124 being configured to engage another panel 130. The slat 140 can further define a slat recess 148 that extends between the tooth 124 and an adjacent slider 150 on a corresponding lateral side of the slat 140. For example, while the tooth 124 can extend from the upper side 121 of the panel 130 at the slat 140, the slat recess 148 can provide more clearance by extending a lesser distance from the upper side 121 of the panel 130 at the slat 140.

As further shown in FIG. 10, the slider 150 can define one or more structures at the first longitudinal side 125 of the panel 130. The slider 150 can further define a slider recess 158 that extends between the lateral side 153 defined by the slider 150 and the slat 140. For example, one or more portions of the slider can extend from the upper side 121 of the panel 130 at the slider 150, the slider recess 158 can provide more clearance by extending a lesser distance from the upper side 121 of the panel 130 at the slider 150.

The slat recess 148 and the slider recess 158 can form voids or spaces defined by the peripheral edges of the corresponding structures. For example, the slat recess 148 can be defined by an edge of the slat 140, and the slider recess 158 can be defined by an edge of the slider 150. In some embodiments, the slat recess 148 and the slider recess 158 can be flush with each other to define a continuous edge and/or boundary. The panels 130 can include the ramp 128 that faces the slat recess 148 and the slider recess 158.

The slat recess 148 and the slider recess 158 are configured to receive a portion of a cover driver (not shown) upon longitudinal movement of the panel 130 past the cover driver. For example, when the panel 130 is engaged by the cover driver (e.g., at the sliders 150), the panel 130 can move longitudinally. Upon sufficient movement, the ramp 128 will allow an underlying panel 130 to move upward toward the overlapping panel 130 and/or the overlapping panel 130 to move downward toward the underlying panel 130. Such adjustments facilitated by the ramp 128 can facilitate engagement between panels 130 but also shift the height of one or more panels 130. Accordingly, it can be desirable to provide adequate clearance so the structures at the first longitudinal side 125 of the panels 130 do not interfere with the cover driver. For example, where the gear drive includes a pinion gear, the corresponding rack of the sliders 150 can align with the slat recess 148 and the slider recess 158, so that the panels 130 and sliders 150 can travel over the cover driver without catching on the pinion gear. Additional clearance can be provided by the slat recess 148 and the slider recess 158 to exceed the maximum dimensions of the pinion gear and/or other portions of the cover driver. While the cover driver can be configured to engage the sliders 150, the cutout may optionally extend to the slats 140 of the panels 130 with the slat recess 148, so that ample clearance is provided even when panels 130 are laterally misaligned.

While FIG. 10 illustrates only one lateral side of the panels 130, it will be understood that the panels 130 can include the same or similar features on each of opposing lateral sides thereof. For example, the sides of the slats 140 and the sliders 150 on opposing lateral sides of the slats 140 can have symmetrical features, including the slat recess 148 and the slider recess 158.

Accordingly, aspects of the subject disclosure provide cover systems that include features that interact with each other to facilitate loading and unloading of panels linearly and with high stability. Such features can provide smooth deployment and retraction of the tonneau cover. A tonneau cover can include individual panels that interlock with each other upon deployment and disconnect from each other upon retraction to controllably cover a truck bed or other region of a vehicle, such as a truck. Tonneau covers described herein can include panels that provide reliable sealing there between. Tonneau covers described herein can include panels that provide smooth sliding across each other and along one or more rails. Tonneau covers described herein can perform such operations with minimal noise generation.

The following patents and applications are hereby incorporated by reference in their entirety, as is fully set forth herein: U.S. Pat. Nos. 11,318,826; 10,525,804; 11,091,013; and U.S. Pat. Pub. No. 2022/0048435.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A seal for a panel of a vehicle tonneau cover, the seal comprising:
a stem having a first end and a second end;
a first branch extending away from a middle portion between the first end and the second end; and
a second branch extending from the first end of the stem and across an end of the first branch.

2. The seal of claim 1, further comprising an anchor portion extending from the first end of the stem in a direction that is away from the second branch.

3. The seal of claim 2, wherein:
the anchor portion is a first anchor portion; and
the seal further comprises a second anchor portion extending from the second end of the stem, wherein the first anchor portion and the second anchor portion are configured to partially surround a bulb of the panel.

4. The seal of claim 1, wherein the second branch defines a curve from the first end of the stem and across the end of the first branch.

5. The seal of claim 1, wherein the stem, the first branch, and the second branch define a cross-sectional shape that extends in a direction across an entire width of the seal.

6. A panel of a tonneau cover, the panel comprising:
a slat defining a receptacle at a longitudinal side of the tonneau cover;
a pair of sliders at opposing lateral sides of the slat; and
the seal of claim 1, the seal being secured within the receptacle and extending between the pair of the sliders.

7. The panel of claim 6, wherein:
the seal is an outer seal; and
the panel further comprises an inner seal secured within the receptacle and extending between the pair of the sliders, the inner seal comprising:
an inner seal stem having an inner seal first end and an inner seal second end;
an inner seal branch extending away from the first end and towards the outer seal, wherein the inner seal stem and the inner seal branch form an indentation having a dimension that is greater than a dimension of an opening to the indentation; and
an inner seal anchor portion extending from the first end of the inner seal stem in a direction that is away from the second branch.

8. The panel of claim 7, wherein the inner seal stem, the inner seal branch, and the inner seal anchor portion define an inner seal cross-sectional shape that extends across an entire width of the inner seal.

9. The panel of claim 7, wherein:
the indentation is a first indentation; and
the inner seal branch forms a second indentation between the first indentation and a terminal end of the inner seal branch, the first indentation facing towards the inner seal stem.

10. The panel of claim 7, wherein, when a tooth of another panel is received within the receptacle, the first branch of the outer seal is configured to engage an inner side of the tooth and the inner seal branch of the inner seal is configured to engage an outer side of the tooth.

11. A panel for a vehicle tonneau cover, the panel comprising:
a slat defining a tooth configured to engage a receptacle of an adjacent panel; and
sliders on opposing lateral sides of the slat, wherein each of the sliders defines a planar surface on an upper side of the panel and a bump protruding from the planar surface, wherein the bump extends laterally across the planar surface from a lateral side of the corresponding one of the sliders.

12. The panel of claim 11, wherein a width of the bump is substantially equal to a width of the planar surface.

13. The panel of claim 11, wherein each of the sliders further defines an additional planar surface at a lower side of the panel, opposite the upper side of the panel, wherein the width of the bump is substantially equal to a width of the additional planar surface.

14. The panel of claim 11, wherein the panel defines a ramp extending from a lower side of the panel toward the upper side of the panel, wherein the panel faces away from the bump.

15. The panel of claim 11, wherein the bump on each of the slides extends towards the other of the sliders.

16. The panel of claim 11, wherein each of the sliders comprises a longitudinal end, opposite the bump, forming a shape comprising a chamfer, curve, bevel, fillet, radius, or taper.

17. A panel for a vehicle tonneau cover, the panel comprising:
a slat defining a tooth extending from an upper side of the panel, defining a longitudinal end of the slat, and being configured to engage a receptacle of an adjacent panel;
a first slider on a first lateral side of the slat; and
a second slider on a second lateral side of the slat,
wherein the slat defines a slat recess between the tooth and the first slider,
wherein the first slider defines a slider recess adjacent to the slat recess, wherein the slat recess and the slider recess are configured to receive a portion of a cover driver upon longitudinal movement of the panel.

18. The panel of claim 17, wherein the panel defines a ramp extending from a lower side of the panel toward the upper side of the panel, wherein the ramp faces the slat recess and the slider recess.

19. The panel of claim 17, wherein the portion of the cover driver is a pinion gear configured to engage a portion of the first slider.

20. The panel of claim 17, wherein:
the slat recess is a first slat recess;
the slider recess is a first slider recess;
the slat further defines a second slat recess between the tooth and the second slider; and
the second slider defines a second slider recess adjacent to the second slat recess, wherein the second slat recess and the second slider recess are configured to receive an additional portion of the cover driver upon longitudinal movement of the panel.
